(19) United States
(12) Patent Application Publication
(10) Pub. No.: US 2026/0357453 A1
(43) Pub. Date: Nov. 12, 2026

(54) BUBBLE RELEASE STOMATA WITHIN LAYERS OF ELECTROCHEMICAL CELLS

(71) Applicant: ELECTRIC HYDROGEN CO., Devens, MA (US)

(72) Inventors: Elif Karatay, Mountain View, CA (US); Ruofan Wang, Centennial, CO (US)

(21) Appl. No.: 19/125,895

(22) PCT Filed: Mar. 25, 2024
(86) PCT No.: PCT/US2024/021348

§ 371 Date: Apr. 30, 2025

Related U.S. Application Data
(60) Provisional application No. 63/454,904, filed on Mar. 27, 2023.

(51) Int. Cl. C25B 11/032; C25B 9/23; C25B 9/70; C25B 11/056; C25B 11/063; C25B 13/08

(52) U.S. Cl. CPC C25B 11/032; C25B 9/23; C25B 9/70; C25B 11/056; C25B 11/063; C25B 13/08

(57) ABSTRACT

The following disclosure relates to electrochemical or electrolysis cells and components thereof. More specifically, the following disclosure relates to porous transport layers (PTLs) and gas diffusion layers (GDLs) including stomata and improved flow fields within electrochemical cells. The disclosure further includes a method of manufacturing a porous layer including casting a slurry comprising a metal powder.

This application claims the benefit of U.S. Provisional Patent Application No. 63/454,904, filed Mar. 27, 2023, which is hereby incorporated by reference in its entirety.

### FIELD

The following disclosure relates to electrochemical or electrolysis cells and components thereof. More specifically, the following disclosure relates to porous transport layers (PTLs) and gas diffusion layers (GDLs) including stomata in the surface of the PTLs or GDLs and improved flow fields within electrochemical cells.

### BACKGROUND

Hydrogen has been considered as an ideal energy carrier to store renewable energy. Proton exchange membrane water electrolysis (PEMWE) as a means for hydrogen production offers high product purity, fast load response times, small footprints, high efficiencies, and low maintenance efforts. It is regarded as a promising technology, especially when coupled with renewable energy sources.

An electrolysis cell or system uses electrical energy to drive a chemical reaction. For example, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive the installation of electrolyzer systems.

Porous transport layers (PTLs) and gas diffusion layers (GDLs) play important roles in electrochemical cell performance. A PTL, positioned between an anode catalyst layer and an anode flow field of the electrochemical cell, may assist in transporting water and oxygen on the anode side and in transporting electrons away from the anode catalyst layer. A GDL, positioned between a cathode catalyst layer and a cathode flow field of the electrochemical cell, may assist in transporting hydrogen on the cathode side of the cell and in transporting electrons towards the cathode catalyst layer.

There remains a desire for improved performance properties within electrochemical cells, including improved fluid transport within the cell.

### SUMMARY

In one embodiment, a porous layer configured to convey a two-phase mixture of liquid and gas is provided. The porous layer includes stomata positioned on a surface of the porous layer, wherein the stomata are configured to facilitate a transfer of gas from the porous layer into an adjacent flow field of an electrochemical cell.

In another embodiment, an electrochemical cell includes a flow field, a porous layer adjacent to the flow field configured to convey a two-phase mixture of liquid and gas, and stomata positioned on a surface of the porous layer adjacent to the flow field, wherein the stomata are configured to facilitate a transfer of gas from the porous layer to the flow field.

In another embodiment, an electrochemical cell stack includes a first electrochemical cell and a second electrochemical cell. The first electrochemical cell includes a first flow field, a first porous layer adjacent to the first flow field configured to convey a two-phase mixture of liquid and gas, and a first plurality of stoma positioned on a surface of the first porous layer adjacent to the first flow field, the first plurality of stoma having a first pattern and configured to facilitate a transfer of gas from the first porous layer to the first flow field. The second electrochemical cell includes a second flow field, a second porous layer adjacent to the second flow field configured to convey a two-phase mixture of liquid and gas, and a second plurality of stoma positioned on a surface of the second porous layer adjacent to the second electrode, the second plurality of stoma having a second pattern different from the first pattern and configured to facilitate a transfer of gas from the second porous layer to the second flow field.

In another embodiment, a method of manufacturing a porous layer including stomata includes casting a slurry including a metal powder on to a substrate, drying the slurry to form a green state tape, and sintering the green state tape to form a solid porous layer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrolytic cell.

FIG. 2 depicts an additional example of an electrolytic cell.

FIGS. 3A, 3B, and 3C depict cross-sectional views of an example of an electrochemical cell with a limited number of flow channels of flow fields depicted for clarity.

FIGS. 4A and 4B depict a side view and a top view, respectively, of portions of such an electrode flow field having a limited number of flow channels and lands depicted for clarity.

FIG. 5 illustrates a section of one interface of an electrochemical cell.

FIGS. 6A and 6B illustrate bubble distributions in two identical electrochemical cells operating at different power levels.

FIGS. 7A and 7B illustrate a porous layer and a catalyst layer of an electrochemical cell. FIG. 7A illustrates a porous layer without water and FIG. 7B illustrates a porous layer including water and gas bubbles.

FIGS. 8A and 8B illustrate a porous layer including stomata and a catalyst layer of an electrochemical cell. FIG. 8A illustrates a porous layer including stomata without water and FIG. 8B illustrates a porous layer including stomata with water and gas bubbles.

FIGS. 9A-9E illustrate side cross-sectional views of porous layers including different shaped stomata.

FIGS. 10A-10F illustrate different distributions or frequencies of stomata in porous layers.

FIGS. 11A-11D illustrate different arrangements of connected stomata in porous layers.

FIGS. 12A-12D illustrate different arrangements of stomata in porous layer relative to lands and/or channels of an electrode including a flow field.

FIG. 13 illustrates an electrolyzer cell stack including identical porous layers without stomata and an electrolyzer cell stack including porous layers with different stomata distributions at different cells.

FIGS. 14A-14C illustrate a method of manufacturing a porous layer including stomata using a substrate including protrusion.

FIGS. 15A and 15B illustrate a method of manufacturing a porous layer including stomata using a patterned roller.

FIGS. 16A-16E illustrate a method of manufacturing a porous layer including stomata using a sacrificial material.

### DETAILED DESCRIPTION

The following disclosure provides improved porous transport layers (PTLs) and gas diffusion layers (GDLs) in an electrochemical or electrolytic cell for hydrogen gas and oxygen gas production through the splitting of water. Further, the following disclosure provides various processes for making the improved PTLs and GDLs, such as, PTLs and GDLs, including bubble release stomata.

As described herein, the term “stomata” may refer to surface cavities, surface macro-voids, or surface macro-pores within the surface of the porous layer (e.g., porous transport layer, gas diffusion layer) that are configured to promote facile release of gas products from the porous layer into the adjacent flow field. In certain examples, the largest width or diameter of the opening of the cavity or stomata in the surface of the porous layer may be greater than 0.1 micron, greater than 1 microns, greater than 5 microns, greater than 10 microns, in a range of 0.1-50 microns, or in a range of 1-10 microns. Additionally, in certain examples, the depth or distance which the cavity or stomata extends into the porous layer may be less than 500 microns, less than 300 microns, less than 150 microns, less than 50 microns, more than 10 microns, in a range of 10-500 microns, in a range of 10-300 microns, in a range of 10-150 microns, or in a range of 10-50 microns.

A plurality of bubble release stomata may advantageously provide cavities, macro-voids, or macro-pores within the porous layer (e.g., the PTL or GDL) that are large enough to allow gas bubbles to flow through without being trapped. Accordingly, the gaseous product or gas bubbles formed in the water splitting reaction in the electrochemical cell may flow from nucleation sites or high gas saturation regions into the stomata and to a surface of the porous layer 520 adjacent to a flow field of the electrochemical cell. The gaseous product may then flow through the channels of the flow field, exiting the cell. Thus, the stomata may advantageously facilitate an improved fluid transfer or removal of gas (e.g., gaseous product) from the porous layer in comparison with a similar electrochemical cell not including such stomata in the porous layer (e.g., PTL or GDL) of the cell. The stomata may advantageously reduce an average duration of time required for gas bubbles to exit the porous layer of the electrochemical cell and thus the cell in its entirety, therein improving the efficiency of the electrochemical cell.

Cavities or stomata within the surface of the porous layer may advantageously allow for an increase in an amount of reactant water supplied to the membrane/catalyst layer of the cell, therein allowing the cell to operate at higher power levels without a mass transfer limitation occurring, improving efficiency of the electrochemical cell. Additionally, improving efficiency of the removal of gaseous products from the cell may advantageously create a more uniform gas-liquid distribution in the porous layers of the cell. Engineered macro-pore structures or stomata would provide pathways for gas to be released preventing large regions to be occupied by gas. This may avoid generation of hot spots and may advantageously provide a more uniform temperature distribution across the cell.

Such improved porous layers with bubble release stomata, electrochemical cells and stacks including such improved porous layers, and methods of making such improved porous layers are disclosed in greater detail below.

### Electrochemical Cells

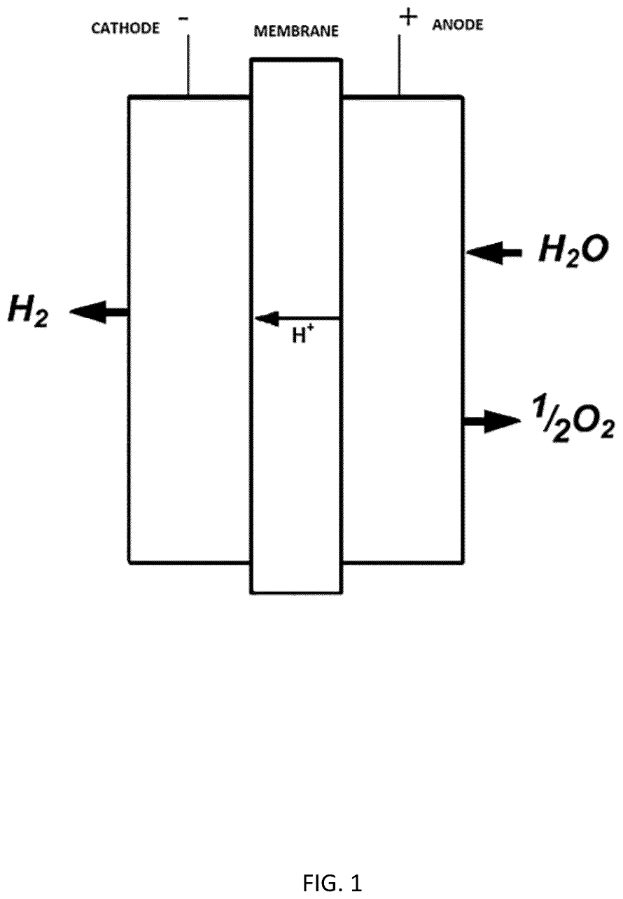

FIG. 1 depicts an example of an electrochemical or electrolytic cell for hydrogen gas and oxygen gas production through the splitting of water. The electrolytic cell includes a cathode, an anode, and a membrane positioned between the cathode and the anode. The membrane may be a catalyst coated membrane (CCM) such as a proton exchange membrane (PEM). Proton exchange membrane (PEM) electrolysis involves the use of solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂.

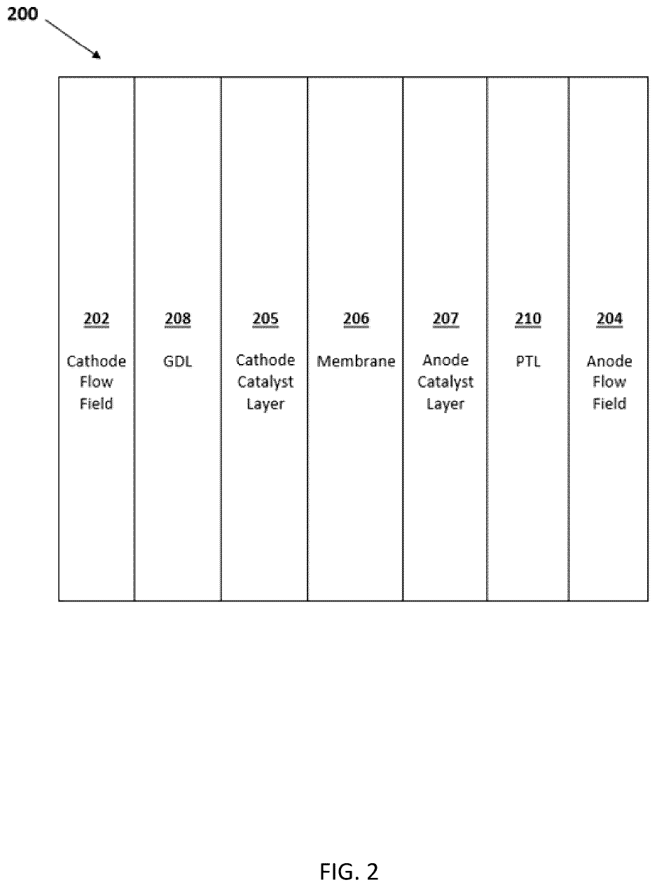

FIG. 2 depicts an additional example of an electrochemical or electrolytic cell. Specifically, FIG. 2 depicts a portion of an electrochemical cell 200 having a cathode flow field 202 and an anode flow field 204, and a membrane 206 positioned between the cathode flow field 202 and the anode field 204.

In certain examples, the membrane 206 may be a catalyst coated membrane (CCM) having a cathode catalyst layer 205 and/or an anode catalyst layer 207 positioned on respective surfaces of the membrane 206. In proton exchange membrane water electrolysis (PEMWE), the proton exchange membrane may be a perfluorosulfonic acid (PFSA) based polymer. As used throughout this disclosure, the term “membrane” may refer to a catalyst coated membrane (CCM) having such catalyst layers.

In certain examples, additional layers may be present within the electrochemical cell 200. For example, one or more additional layers may be positioned between the anode flow field 204 and the membrane 206. In certain examples, this may include a porous transport layer (PTL) 210 positioned between the membrane 206 (e.g., the anode catalyst layer 207 of the catalyst coated membrane 206) and the anode flow field 204.

In certain examples, the PTL 210 may include a porous titanium fiber felt, a porous sintered titanium particle sheet, or a combination thereof. Each side of the PTL 210 may have a homogeneous surface profile consisting of stomata and either titanium (Ti) particles or Ti fibers. The PTL 210 is configured to allow the transportation of reactant water to the anode catalyst layers, remove produced oxygen gas, and provide good electrical conductivity for effective electron conduction. The thickness of the PTL 210 may be in the range of 100-1000 microns, for example. The thickness may affect the mass transport within the cell as well as the durability/deformability and electrical/thermal conductivity of the PTL 210. In other words, a thinner PTL 210 may provide better mass transport and a reduction in durability (e.g., greater chance for localized deformation).

In some examples, an anode catalyst coating layer may be positioned between the anode flow field 204 and the PTL 210.

Similarly, one or more additional layers may be present in the electrochemical cell between the membrane 206 and the cathode flow field 202. In certain examples, this may include a gas diffusion layer (GDL) 208 positioned between the cathode flow field 202 and membrane 206. This may be advantageous in providing diffusion pathways for hydrogen to move away from a cathode catalyst layer, into the cathode flow field.

In certain examples, the GDL 208 is made from a carbon paper or woven carbon fabrics. The GDL 208 is configured to allow the flow of hydrogen gas to pass through it. The thickness of the GDL 208 may be within a range of 100-1000 microns, for example. The thickness may affect the mass transport within the cell as well as the durability/deformability and electrical/thermal conductivity of the GDL 208. In other words, a thinner GDL 208 may provide better mass transport, lower resistance, and a reduction in durability (e.g., greater chance for localized deformation).

The cathode flow field 202 and anode flow field 204 of the cell may individually include a flow field plate composed of metal, carbon, or a composite material having a set of channels machined, stamped, or etched into the plate to allow fluids to flow inward toward the membrane or out of the cell.

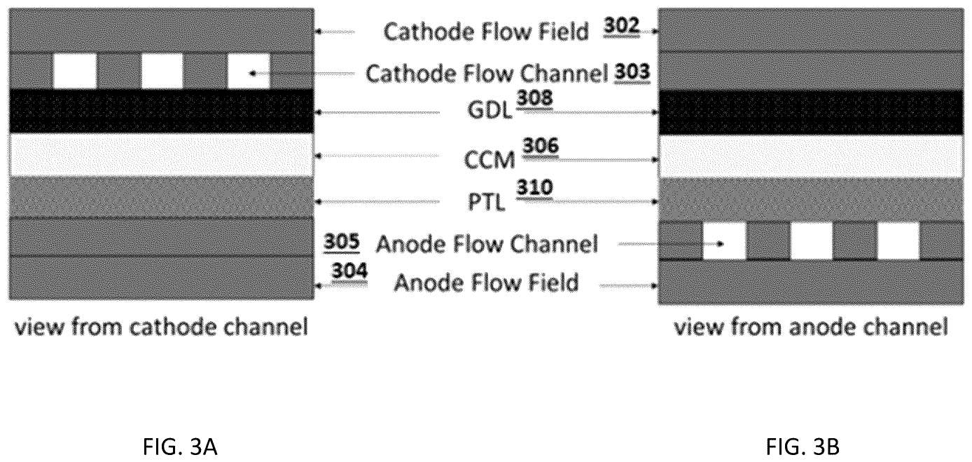

FIGS. 3A, 3B, and 3C depict such an example of an electrochemical or electrolytic cell, wherein examples of flow fields are depicted. In this particular example, the electrochemical cell includes a cathode flow field 302, cathode flow channels 303, an anode flow field 304, anode flow channels 305, and a membrane 306 positioned between the cathode and the anode. Additionally, the electrochemical cell 300 includes a gas diffusion layer 308 positioned between the catalyst coated membrane 306 and the cathode flow channels 303. Further, a porous transport layer 310 is positioned between the catalyst coated membrane 306 and the anode flow channels 305. The porous transport layer 310 may be the same as the porous transport layer 210 and the gas diffusion layer 308 may be the same as the gas diffusion layer 208.

In the particular example depicted in FIGS. 3A and 3B, the cathode and anode flow fields are arranged to provide a cross-fluid flow. In such a cross-fluid arrangement, the fluid flow through the cathode flow channels is arranged perpendicular to the fluid flow through the anode flow channels. Specifically, FIG. 3A depicts the cross-sectional view of the electrochemical cell with the cathode flow channels displayed, while FIG. 3B depicts the cross-sectional view of the electrochemical cell rotated 90 degrees to display the anode flow channels.

In alternative examples, the flow fields may have a co-flow configuration or a counter-flow configuration. FIG. 3C depicts an alternative example, wherein the channels and lands of the anode flow field are parallel with the channels and lands of the cathode flow field, therein allowing for a co-flow or a counter-flow configuration. In a co-flow configuration, the flow of fluid through the anode flow field channels is in the same direction as the flow of fluid through the cathode flow field channels. Alternatively, a counter-flow configuration may be present with the parallel arrangement of the anode and cathode flow fields, wherein the flow of fluid through the anode flow field channels is in an opposite direction as the flow of fluid through the cathode flow field channels.

The orientation or configuration of the fluid flow between the anode flow field and cathode flow field may be advantageous in adjusting or controlling the pressure distribution or temperature distribution within the electrochemical cell.

Regarding these anode and cathode flow fields depicted on FIGS. 3A and 3B, such flow fields may be configured to have the paths of channels and lands. The channels are configured for directing the flow of fluid (e.g., water and gas), while the lands are configured to contact an adjacent layer of the electrochemical cell (e.g., a porous layer, PTL 310, GDL 308). FIGS. 3A and 3B depict examples of cells having three cathode flow channels and three anode flow channels, respectively. The number of flow channels are depicted for simplicity of design, and in potential commercial use, may include many more flow channels. As such, the disclosure is not limited to such configurations as depicted in FIGS. 3A and 3B.

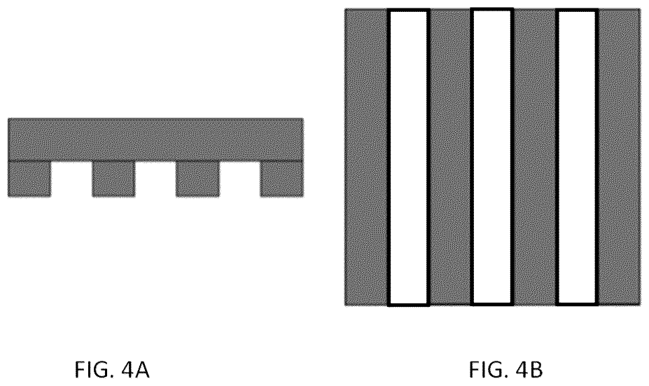

FIGS. 4A and 4B depict a sideview and a top view, respectively, of such an electrode flow field having a plurality of channels and lands. In this particular example, the flow field includes 3 parallel channels and 4 lands, wherein each channel is positioned between the adjacent lands.

As noted above, in the example depicted in FIGS. 3A and 3B, the direction of fluid flow within the cathode flow field and the anode flow field may have a cross-flow configuration, wherein the flow of fluid through the anode flow field channels is in an offset direction (e.g., 90 degrees offset) from the flow of fluid through the cathode flow field channels.

In alternative examples, the flow fields may have a co-flow configuration, or a counter-flow configuration. For example, in a co-flow configuration, the flow of fluid through the anode flow field channels is in the same direction as the flow of fluid through the cathode flow field channels. In a counter-flow configuration, the flow of fluid through the anode flow field channels is in an opposite direction as the flow of fluid through the cathode flow field channels.

The orientation or configuration of fluid flow between the anode flow field and cathode flow field may be advantageous in adjusting or controlling the pressure distribution or temperature distribution within the electrochemical cell.

For parallel channel flow fields, regardless of flow direction, the channels from cathode and channels from anode may be in a cross pattern or parallel pattern. Additional channel patterns are also possible.

In alternative examples, flow field could be composed of an open porous structure that can be expanded mesh, mesh screen and similar metal meshes that may be stacked or single layer. Open porous flow field structure may have varying cavity or pore sizes compatible with stomata in PTL or GDL.

During proton exchange membrane water electrolysis (PEMWE) an oxygen evolution reaction (OER) may occur on an anode interface or side of an electrochemical or electrolytic cell and a hydrogen evolution reaction (HER) may occur on a cathode interface or side of the cell. For an oxygen evolution reaction (OER) occurring at an anode interface (e.g., at an anode catalyst layer) water is a reactant and is often in liquid phase. In some examples, water may be provided to a cathode interface of the cell, e.g., as a cooling source for the cathode side of the cell.

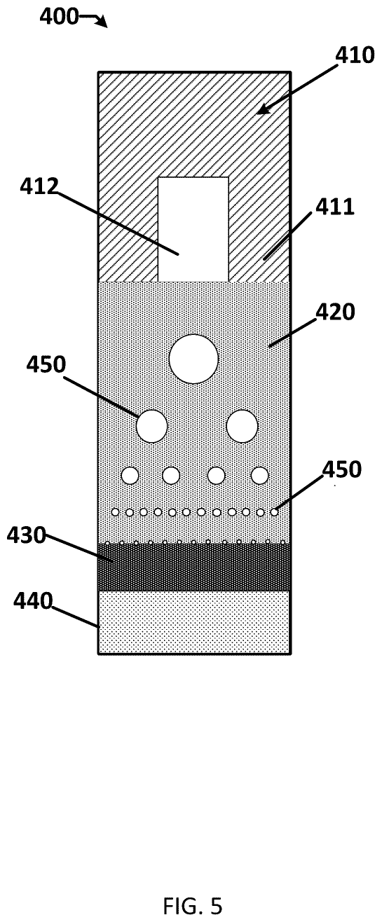

FIG. 5 illustrates a section of one interface (e.g., anode interface, cathode interface) of an electrochemical or electrolytic cell 400. The cell 400 may include a flow field 410, a porous layer 420 (e.g., a porous transport layer or gas diffusion layer), a catalyst layer 430, and a proton exchange membrane 440.

The flow field 410 may be an anode flow field (e.g., anode flow field 204, 304) or a cathode flow field (e.g., cathode flow field 202, 302). As disclosed herein, the flow field 410 may be any type of flow field known in the art for use in an electrochemical cell.

In certain examples, the flow field 410 may include a plurality of lands 411 and a plurality of channels 412. As illustrated in FIG. 5, the flow field 410 include two lands 411 and a single channel 412; however, the present disclosure is not limited thereto. Additional lands 411 and channels 412 may be included. The lands 411 define or separate channels 412 of flow field 410. The lands 411 may be adjacent to and in contact with the porous layer 420 of the cell 400. The channels 412 of the cell may be connected to an inlet and/or outlet of the flow field 410. The channels 412 are configured to convey a flow of fluid. The channels 412 may be configured to both convey a flow of fluid into the porous layer 420 and receive a flow of fluid from the porous layer 420. For example, when the flow field 410 is an anode flow field, the channels 412 may be configured to both convey a flow of water from an inlet of the flow field 410 into the porous transport layer 420 and receive a flow of oxygen and water from the porous transport layer 420 from the water splitting reaction at the membrane and convey the oxygen and water to an outlet of the anode flow field 410.

In another example, when the flow field 410 is a cathode flow field, the channels 412 may be configured to receive a flow of hydrogen (and, in some cases, water) from the porous transport layer 420 from the water splitting reaction at the membrane and convey the hydrogen (and potentially water) to an outlet of the flow field 410. In other examples, when the flow field 410 is a cathode flow field, the channels 412 may be configured to both convey a flow of water from an inlet of the flow field 410 into the porous transport layer 420 and receive a flow of hydrogen (and, e.g., water) from the porous transport layer 420 and convey the hydrogen (and, e.g., water) to an outlet of the cathode flow field.

The porous layer 420 may be a porous transport layer (PTL) (e.g., PTL 210, 310) or a gas diffusion layer (GDL) (e.g., GDL 208, 308). The porous layer 420 may be disposed between the flow field 410 and the catalyst layer 430. The porous layer 420 may be configured to convey fluid. For example, the porous layer 420 may be configured to convey a flow of fluid from the channels 412 of the flow field 410 to the catalyst layer 430 and/or convey a flow of fluid from the catalyst layer 430 to the channels 412 of the flow field 410. For example, when the porous layer 420 is a PTL, the porous layer may be configured to convey a flow of liquid water from the channels 412 of the flow field 410 to the catalyst layer 430 and convey a flow of gaseous oxygen from the catalyst layer 430 to the channels 412 of the flow filed 410. In another example, when the porous layer 420 is a gas diffusion layer, the porous layer may be configured to convey a flow of gaseous hydrogen from the catalyst layer 430 to the channels 412 of the flow field 410.

The catalyst layer 430 may refer to an anode catalyst layer (e.g., anode catalyst layer 207) or a cathode analyst layer (e.g., cathode catalyst layer 205). The catalyst layer 430 may be a catalyst for facilitating the water splitting reaction occurring on a given interface of the cell 400. For example, when the catalyst layer is an anode catalyst layer, the catalyst layer 430 may be a catalyst for the oxygen evolution reaction (OER) occurring at the anode interface of the cell. In another example, when the catalyst layer 430 is a cathode catalyst layer, the catalyst layer 420 may be a catalyst for the hydrogen evolution reaction (HER) occurring at the cathode interface of the cell 400. Gaseous products (e.g., hydrogen, oxygen) may be produced at or near the catalyst layer 430.

The proton exchange membrane 440 may be disposed between an anode catalyst layer and a cathode catalyst layer of the cell 400. The proton exchange membrane 440 may be configured to convey or transport protons from the anode interface of the cell 400 to the cathode interface of the cell 400. In some examples, the proton exchange membrane 440 may be a catalyst coated membrane and include the anode catalyst layer and/or the cathode catalyst layer.

FIG. 5 illustrates operation of one interface of the cell 400 during water electrolysis. During operation of the cell 400, water may flow through the channels 412 of the flow field 410 into the porous layer 420 of the cell 400. The porous transport layer 420 may convey the flow of water toward the catalyst layer 430. When the water reaches the catalyst layer 430, a gas generating reaction (e.g., the water splitting reaction) may occur. For example, at an anode interface, an oxygen evolution reaction (OER) may occur. For example, two moles of water may be split into four moles of protons, four moles of electrons, and one mole of oxygen. Similarly, for the water splitting reaction, a hydrogen evolution reaction (HER) may occur at a cathode interface of the cell.

Products of the cell 400, (e.g., oxygen generated by an OER reaction at the anode interface of the cell 400 or hydrogen generated by a HER at the cathode interface of the cell 400), may be generated in a generation region at or near the catalyst layer 430. Oxygen and/or hydrogen generated by the cell 400 may primarily be in a gaseous state. Thus, as the gas generating reactions (e.g., OER, HER), a two-phase mixture of liquid and gas may be created in the porous transport layer 420. Gas generated by the cell 400 may flow through the porous transport layer 420 to the channels 412 of the flow field 410 and through the channels 412 to exit an outlet of the flow field 410.

The physical morphology (e.g., cavity size and cavity distribution) of the porous layer 420 may dictate preferential pathways of gaseous product transport through the porous layer 420 to the channels 412 of the flow field 410. Accordingly, morphology of the porous layer may be tailored or adjusted to better remove gaseous product away from generation regions or reactions cites (e.g., the catalyst layer 430). As gas bubbles move or travel through the porous layer, when the radius of a gas bubble in a cavity of the porous layer is larger than the radius of a capillary tube connected to the cavity, the bubble may be trapped in the cavity. Further, if another gas bubble moves into the cavity including the trapped bubble, the two bubbles may merge together and may form a bigger trapped bubble if the volume of the merged gas bubble is smaller than the volume of the cavity. Another example is gas bubbles being trapped under the land areas for a channel flow field, where convective flow is less compared to areas under the channel areas. Additionally, the morphology of the porous layer may be tailored to better provide liquid water to reaction cites. For example, porous layer morphology may be designed to provide smaller cavity sizes/low porosity to facilitate liquid water transport and high porosity to facilitate gas transport by enabling merging of gaseous bubbles.

Supply of liquid reactant water and removal of gaseous products are crucial for durable and high current density operation of the electrochemical or electrolytic cell. For example, residual oxygen bubbles near a catalyst layer can block water from reacting with the electrocatalyst (e.g., catalyst layer 430) decreasing the efficiency of the cell. Additionally, reactant water may be used to cool the cell. Accordingly, residual bubbles of gaseous products may prevent the flow of water through portions of the porous layer, impacting the thermal performance of the cell.

FIG. 5 illustrates gaseous bubble origination and release across a cross-section of a porous layer. As illustrated in FIG. 5, the gas bubbles 450 are formed at or near the catalyst layer 430. The gas bubbles 450 may then travel through the porous layer 420 to the channels 412 of the flow field 410. As the gas bubbles 450 travel through the porous layer 420 toward the flow field 410, they may merge forming larger gas bubbles 450. Accordingly, as illustrated in FIG. 5, a larger number of small gas bubbles 450 may be present near the catalyst layer 430 and a smaller number of larger gas bubbles 450 may be present further away from the catalyst layer (e.g., toward the flow field 410). In other words, gas bubbles nucleating from a generation region) at or near the catalyst layer 430 may coalesce and increase in size as they travel through the porous transport layer 420 toward the flow field 410.

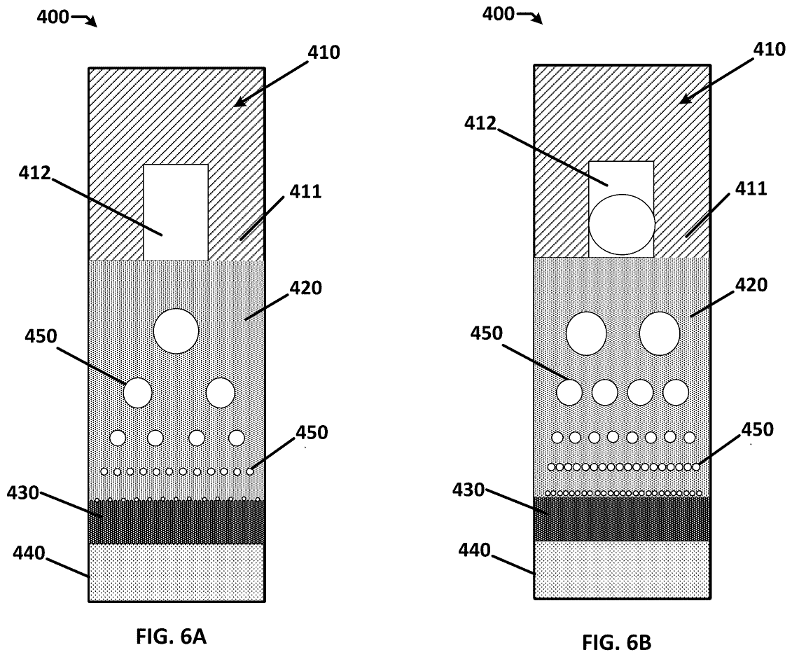

FIGS. 6A and 6B illustrate bubble distributions in two identical electrochemical or electrolytic cells (e.g., cell 400) operating at two different power levels. The power levels at which the cells operate may be a function of the current flowing through the cell. FIG. 6A illustrates a cell 400 operating at a relatively low power and FIG. 6B illustrates a cell 400 operating at a relatively high power. As illustrated in FIGS. 6A and 6B, when the cell 400 is operating at a higher power with identical cell components, more product gas (e.g., oxygen, hydrogen) will be generated. Further, as illustrated in FIGS. 6A and 6B, if the water flow rate through the cell 400 is assumed to be the same, at higher operating power, more porous volume inside the porous layer and more space in the flow field channels will be occupied by gas bubbles 450. The gas bubbles 450 in the porous layer 420 may prevent reactant water from flowing to the catalyst layer 430, causing a mass transfer limitation of the reaction (e.g., oxygen evolution reaction) occurring at or near the catalyst layer 430, limiting the amount of product gas (e.g., oxygen, hydrogen) that may be produced.

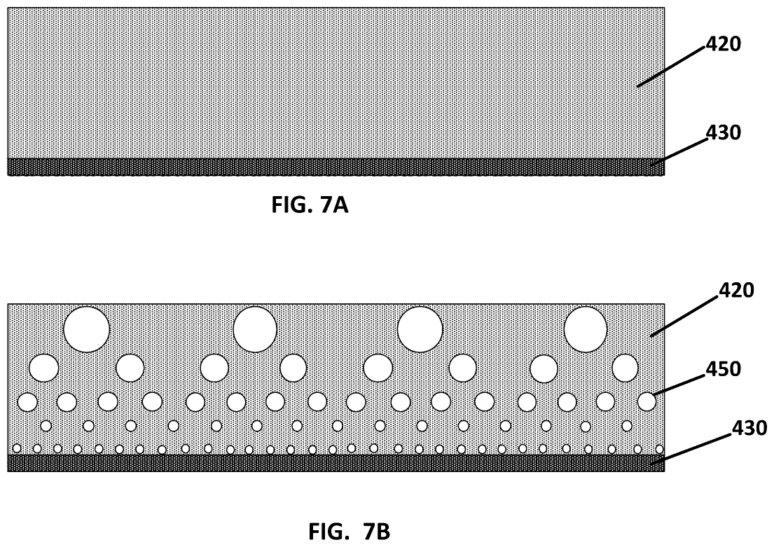

FIGS. 7A and 7B illustrate a porous layer 420 and a catalyst layer 430 of an electrochemical cell. FIG. 7A illustrates the porous layer 420 and catalyst layer 430 when the cell 400 is not operating. FIG. 7B illustrates the porous layer 420 and catalyst layer 430 during operation of the cell. As illustrated in FIG. 7B and discussed above with respect to FIG. 5, during operation of the cell 400 reactant water and gas bubbles 450 may be present in the porous layer 420 of the cell 400.

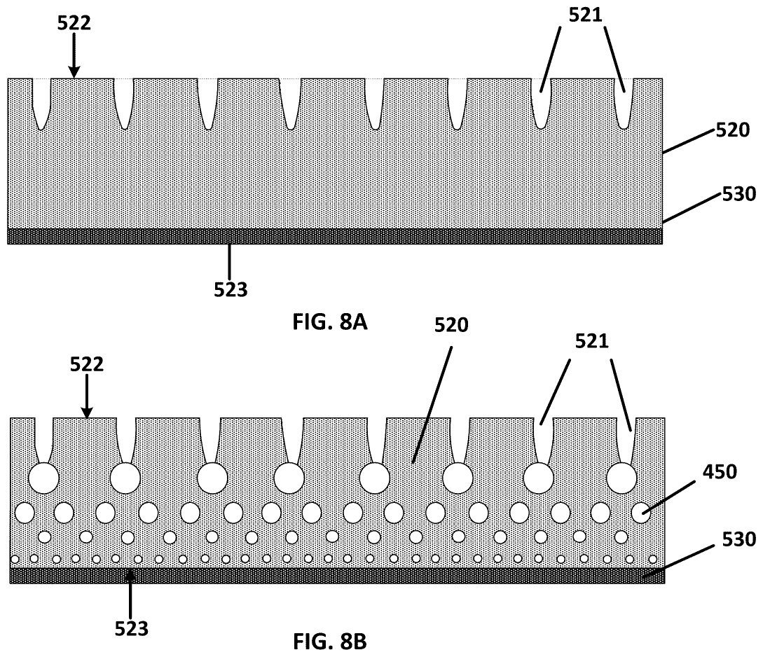

FIGS. 8A and 8B illustrate a porous layer 520 and a catalyst layer 530 of an electrochemical or electrolytic cell 500. FIG. 8A illustrates the porous layer 520 and catalyst layer 530 while the cell 500 is not operating and FIG. 8B illustrates the porous layer 520 and the catalyst layer 530 during operation of the cell 500. The catalyst layer 530 may be the same as the catalyst layer 430. The porous layer 520 may include a first surface 522 adjacent to a flow field (e.g., an anode flow field or cathode flow field of the cell) and a second surface 523, on an opposite side from the first surface 522, adjacent to the catalyst layer 530.

The porous layer 520 includes stomata 521. The stomata 521 may extend into the porous layer 520 from a surface (e.g., first surface 522) of the porous layer 520. Each cavity or stoma of the stomata 521 may form a void or opening in the porous layer 520 extending from a surface of the porous layer into the porous layer 520. Each cavity or stoma of the stomata 521 may extend into the porous layer 520 toward a generation region (e.g., oxygen or hydrogen generation region) and/or the catalyst layer 530. Each cavity or stoma of the stomata may extend toward the generation region or a region of the porous cell having a relatively high saturation of gas in order to advantageously facilitate the removal of gas from the porous layer 520. The stomata may extend into the porous layer 520 from a surface (e.g., first surface 522) of the porous layer 520 adjacent to a flow field.

The shape and size of the stomata may advantageously provide a void or cavity large enough to allow gas bubbles to flow therethrough without being trapped. Accordingly, the gaseous product or gas bubbles formed in the water splitting reaction in the electrochemical cell may flow from generation regions or high gas saturation regions into the stomata and to a surface (e.g., surface 522) of the porous layer 520 adjacent to the flow field. The gaseous product may then flow through the channels of the flow field, exiting the cell. Thus, the stomata may advantageously facilitate an improved fluid transfer or removal of gas (e.g., gaseous product) from the porous layer 520 in comparison with a similar electrochemical cell not including such stomata in the porous layer (e.g., PTL or GDL) of the cell. The stomata may reduce an average duration of time required for gas bubbles to exit the porous layer 520 of the cell 500 and thus the cell 500 in its entirety, improving efficiency of the cell 500.

Improving efficiency of the cell 500, and specifically, improving efficiency of the removal of gaseous product (e.g., gas bubbles 450) from the cell 500 may advantageously increase an amount of reactant water supplied to the catalyst layer 530, allowing the cell 500 to operate at higher power levels without a mass transfer limitation occurring. Additionally, improving efficiency of the removal of gaseous product from the cell 500 may advantageously create a more uniform gas-liquid saturation profile throughout the porous layer 520 of the cell 500. A more uniform gas-liquid saturation profile may advantageously provide a more uniform temperature distribution across the cell 500.

FIG. 8B illustrates the porous layer 520 having stomata 521 and an adjacent catalyst layer 530 during operation of the cell 500. During operation of the cell 500, water may flow into the cell 500 through channels of the flow field. Accordingly, the porous layer 520 may begin to fill with water. Water flowing into the porous layer 520 may be conveyed toward the catalyst layer 530. As the water reaches the catalyst layer 530, a gas generation reaction may occur. Gas bubbles 450 may be generated in the porous layer 520 at or near the catalyst layer 530. The gas bubbles 450 may move through the porous layer 520 toward a flow field adjacent to the surface 522 of the porous layer 520 and/or toward one or more of the stomata 521 of the porous layer 520. For example, the gas bubbles 450 may flow into one of the stomata 521, flow through the stomata, and into a channel of the flow field.

The number of stomata in a porous layer of an electrochemical or electrolytic cell may be configurable. Additionally, the shape and/or size of stomata in a porous layer may also be configurable. The number of stomata, shape of stomata, and size of stomata may be selected based on the electrochemical cell in which they are used. For example, the number of stomata, shape of stomata, and size of stomata used may be a selected based on the type of electrochemical cell, flow field of the electrochemical cell, flow rate of reactant supplied to the electrochemical cell, power of the electrochemical cell, number of cells in an electrochemical cell stack, and the like.

In some examples, the stomata may have a semispherical shape, conical shape, cylindrical shape, frustoconical shape, tetrahedron shape, pyramid shape, prolate spheroid shape, or the like. Each of the stomata may have a side cross-sectional shape and a top cross-sectional shape. The stomata may have a side cross-sectional shape and/or a top cross-sectional shape of a pentagon, rectangle, square, triangle, circle, oval, trapezoid, or the like. The shapes and/or sizes of the stomata are not limited to those illustrated and described herein.

In certain examples, the largest width or diameter of the opening of the cavity or stomata in the surface of the porous layer may be greater than 0.1 micron, greater than 1 microns, greater than 5 microns, greater than 10 microns, in a range of 0.1-50 microns, or in a range of 1-10 microns.

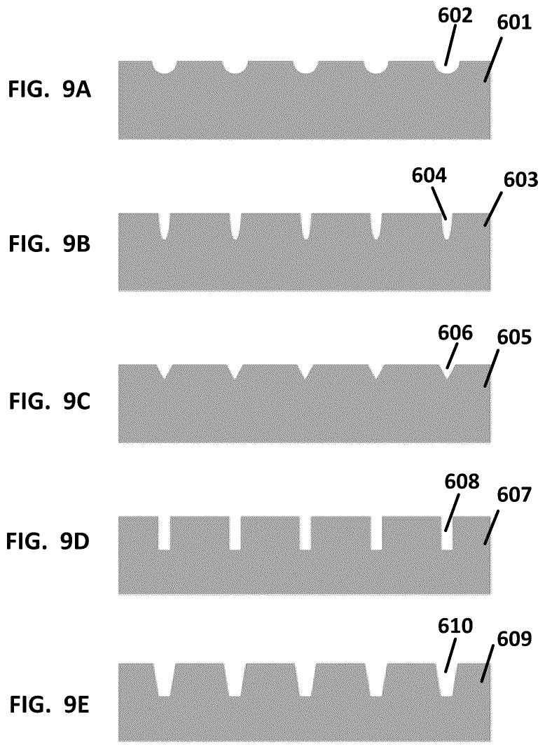

Additionally, a depth or distance which the stomata extend into the porous layer may vary. For example, stomata may extend into the porous layer by less than 500 microns, less than 300 microns, less than 150 microns, less than 50 microns, more than 10 microns, in a range of 10-500 microns, in a range of 10-300 microns, in a range of 10-150 microns, or in a range of 10-50 microns. In other examples, the stomata may extend at least 1%, at least 5%, at least 10%, at least 15%, at least 20%, at least 25%, at least 30%, at least 40%, or at least 50% into the porous layer. In other examples, the stomata may extend 1-50%, 1-40%, 1-30%, 1-25%, 1-20% 5-50%, 5-40%, 5-30%, 5-25%, 5-20%, 10-50%, 10-40%, 10-30%, 10-25%, 10-20%, 15-50%, 15-40%, 15-30%, 15-25%, or 15-20% into the porous layer. FIGS. 9A-9E illustrate a side cross-sectional view of a porous layer including stomata having various side cross-sectional shapes.

FIG. 9A illustrates a side cross-sectional view of a porous layer 601 including stomata 602. As illustrated in FIG. 9A, the stomata 602 may a have a semispherical side cross-sectional shape.

FIG. 9B illustrates a side cross-sectional view of a porous layer 603 including stomata 604. As illustrated in FIG. 9B, the stomata 604 may have a semi-ellipse side cross-sectional shape.

FIG. 9C illustrates a side cross-section view of a porous layer 605 including stomata 606. As illustrated in FIG. 9C, the stomata 606 may have a triangular side cross-sectional shape.

FIG. 9D illustrates a side cross-sectional view of a porous layer 607 including stomata 608. As illustrated in FIG. 9D, the stomata 608 may have a rectangular side-cross sectional shape.

FIG. 9E illustrates a side cross-sectional view of a porous layer 609 including stomata 610. As illustrated in FIG. 9E, the stomata 610 may have a trapezoidal side cross-sectional shape.

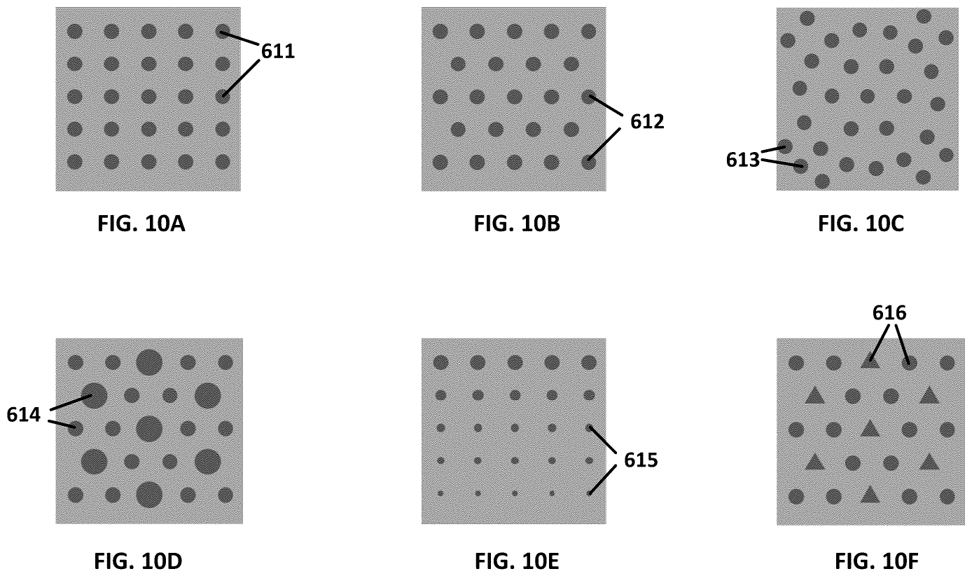

As illustrated in FIGS. 10A-10F, a distribution and/or frequency of stomata in a porous layer may vary. Further, in some examples, the stomata may be arranged in a pattern. The stomata may be arranged in a regular or irregular pattern. For example, as illustrated in FIG. 10A, the stomata 611 may be arranged in a rectangular pattern. In another example, as illustrated in FIG. 10B, the stomata 612 may be arranged in a triangular pattern. In yet another example, as illustrated in FIG. 10C, the stomata 613 may be arranged in a circular pattern.

In some examples, the stomata in a porous layer may have different sizes and/or depths. For example, FIG. 10D illustrates a porous layer including stomata 614 having a circular top cross-sectional shape and two different sizes. The stomata 614 may have any number of different sizes and/or depths. The porous layer may include stomata having any shape in any number of different sizes and/or depths. In another example, as illustrated in FIG. 10E, the stomata 615 may be arranged in a pattern of ascending/descending size. As illustrated in FIG. 10E, the stomata 615 may be arranged in a pattern of ascending/descending size in a horizontal direction in a single direction (e.g., vertical direction, horizontal direction); however, the present disclosure is not limited thereto. For example, the stomata may be arranged in a pattern of ascending/descending size from one or more corners of the porous layer.

In some examples, the stomata in a porous layer may have different shapes. For example, FIG. 10F illustrates a porous layer including stomata 616 having two different shapes. FIG. 10F illustrates stomata 616 including stomata having a circular top cross-sectional shape and stomata having a triangular top cross-sectional shape. As illustrated in FIG. 10F, the stomata includes stomata having two different shapes; however, the present disclosure is not limited thereto, and the porous layer may include stomata having any number of different shapes.

The location distribution, frequency, shape, and/or depth of the stomata may be determined based on a desired or required bubble release speed and/or water flow rate. The location distribution, frequency, shape, and/or depth of the stomata may be determined based on the mechanical properties of the porous transport layer.

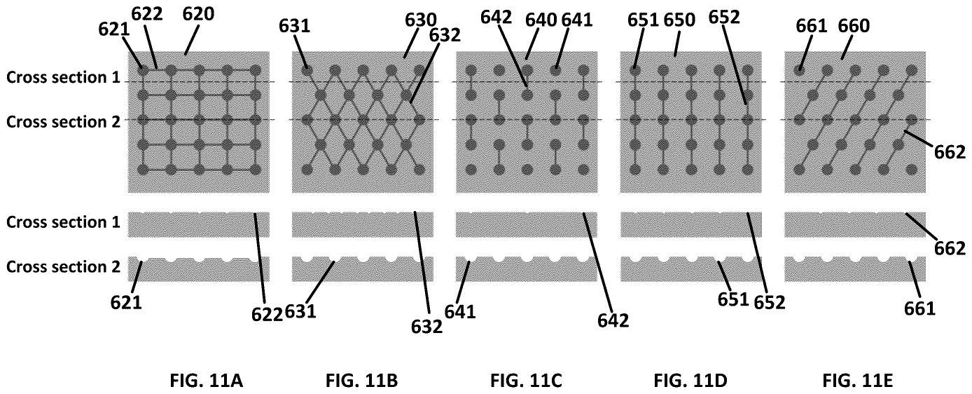

As illustrated in FIGS. 11A-11E, in some examples, two or more of the stomata (e.g., 621, 631, 641, 651, 661) in the porous layers (e.g., 620, 630, 640, 650, 660) may be connected. For example, two or more of the stomata may be connected by a groove (e.g., 622, 632, 642, 652, 662). The groove may extend into the porous layer on the same side of the porous layer as the stomata. A depth to which a groove connecting two or more of the stomata extends may be shorter (e.g., shallower) than a depth which the stomata extend into the porous layer. A groove connecting two or more of the stomata may advantageously create an unimpeded pathway between the two or more stoma allowing a flow of fluid (e.g., gaseous oxygen or hydrogen) to flow directly between the two or more stoma, facilitating the removal of gas from the porous layer and a more uniform distribution of gas and liquid throughout a cell.

The stomata may be connected to form various patterns of stomata connection. In some examples, as illustrated in FIG. 11A, a plurality of grooves 622 may connect the stomata 621 to form a rectangular grid connection. In other examples, as illustrated in FIG. 11B, a plurality of grooves 632 may connect the stomata 631 to form a parallelogram grid connection.

In some examples, as illustrated in FIG. 11C, a groove 642 may connect two of stomata 641 to form a discrete or on and off connection. As illustrated in FIG. 11C, in some examples, a maximum of two of the stomata 641 may be connected to one another. In some examples, two of the stomata 641 may be connected to one another in a vertical direction. In other examples, two of the stomata 641 may be connected in a horizontal direction. In some examples, pairs of connected stomata 641 may be staggered relative to one another.

In some examples, as illustrated in FIG. 11D, a plurality of grooves 652 may connect stomata 651 to form parallel connections. In some examples, the parallel connections may be normal to the channels of a flow field. In other examples, the parallel connections may be parallel to the channels of a flow field. In other examples, as illustrated in FIG. 11E, a plurality of grooves 662 may connect stomata 661 to form parallel connections that intersect with flow channels of a flow field.

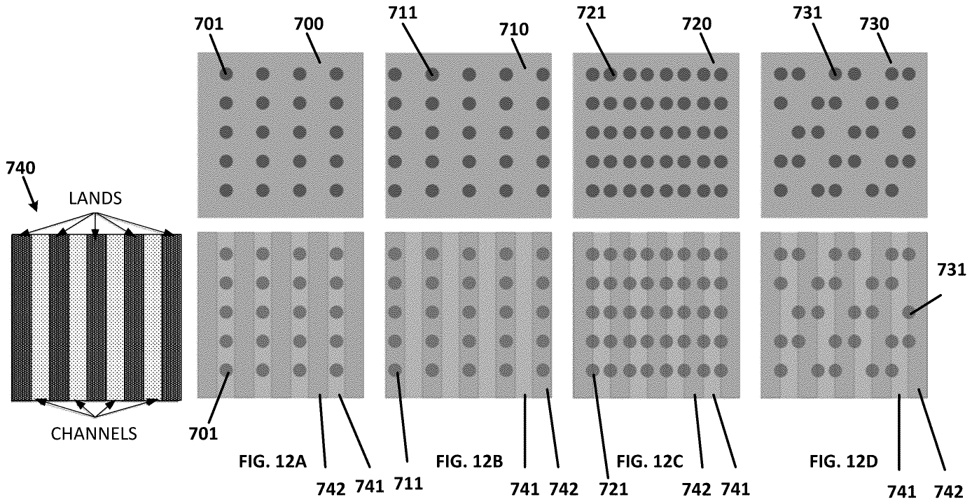

As illustrated in FIGS. 12A-12D, the stomata (e.g., 701, 711, 721, 731) in the porous layer (e.g., 700. 710, 720, 730) may be arranged relative to the channels 741 and/or the lands 742 of the flow field 740. In some examples, as illustrated in FIG. 12A, the stomata 701 may be aligned with the channels 741 of the flow field 740. In other examples, as illustrated in FIG. 12B, the stomata 711 may be aligned with the lands 742 of the flow field 740. In other examples, as illustrated in FIG. 12C, the stomata 721 may be arranged to intersect with the channels 741 and lands 742 of the flow field 740 (such that a portion of a particular cavity or stoma is aligned with a land and a remaining portion of the cavity or stoma is aligned with a channel adjacent to the land). In some examples, as illustrated in FIG. 12D, the stomata 731 may be arranged to intersect with the channels 741 and lands 742 in an irregular pattern (e.g., certain stomata are positioned adjacent to lands, other stomata are positioned adjacent to channels, and other stomata intersect the channels and lands).

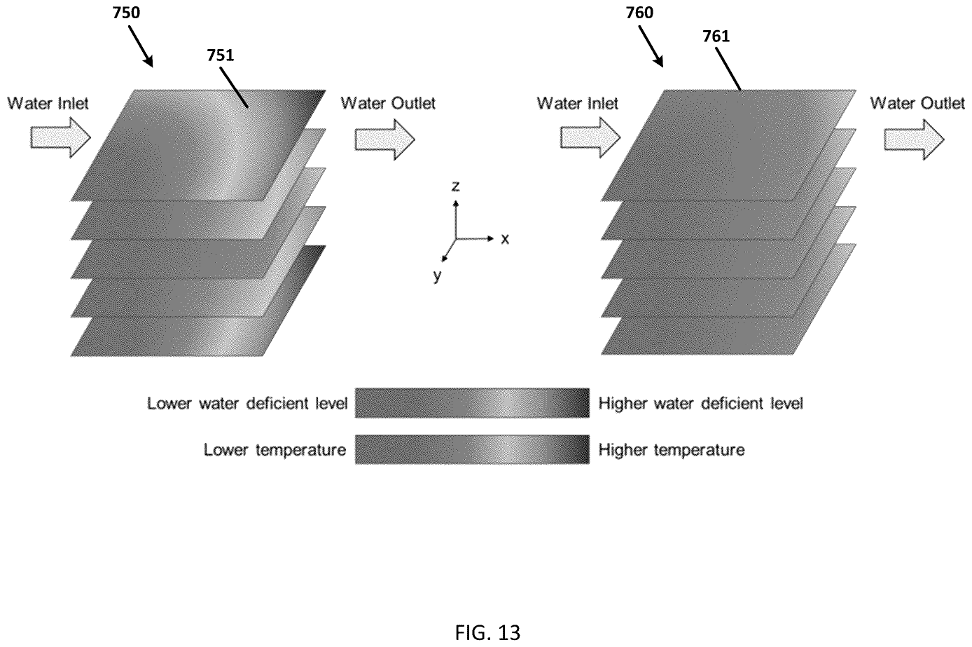

FIG. 13 illustrates an electrolyzer cell stack 750 including identical porous layers within the individual cells of the stack, wherein the porous layer of each cell does not have any stomata. In comparison, a similar electrolyzer cell stack 760 has a plurality of individual cells within the stack, wherein each cell includes a porous layer. In this cell stack, 760 the porous layers of the plurality of cells have different stomata distributions within the different cells.

The electrolyzer cell stack 750 includes a plurality of cells 751. The electrolyzer cell stack 750 includes five cells 751; however, the present disclosure is not limited thereto, and any number of cells may be included. In certain examples, the electrochemical stack may contain 50-1000 cells, 50-100 cells, 500-700 cells, or more than 1000 cells. The electrochemical cells within the electrochemical stack may be configured to operate with 200 mV or less of pure resistive loss when operating at a high current density (e.g., at least 3 Amp/cm² at least 4 Amps/cm², at least 5 Amps/cm², at least 6 Amps/cm², at least 7 Amps/cm², at least 8 Amps/cm², at least 9 Amps/cm², at least 10 Amps/cm², or at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-20 Amps/cm², in a range of 3-15 Amps/cm², in a range of 3-10 Amps/cm², or in a range of 10-20 Amps/cm²). In additional examples, the amount of water (e.g., deionized (DI) water) transferred to or circulated through each cell of the stack may be in a range of 0.25-5 mL/Amp/cell/min.

Each of the cells 751 may include identical porous layers without stomata. Depending on the design of the electrolyzer cell stack 750, a water deficient level profile and/or a temperature profile across the different cells 751 may vary. The variability of the water deficient level profile and/or temperature profile across the different cells may cause issues of large water deficient level gradient and/or temperature gradient in one cell and across the cell stack 750. A large water deficient level gradient and/or temperature gradient may cause insufficient usage of catalyst at different stack locations, differential degradation rate of cell components at different stack locations, and/or higher risk of failure at certain stack locations.

In contrast, the electrolyzer cell stack 760 includes a plurality of cells 761 with different cavity or stomata designs in the porous layers of each of the cells 761. The cavity or stomata design in each of the cells 761 may depend on the electrolyzer cell stack 760 design and the resulting water deficiency level or temperature deficiency level at different cells and different stack locations. As a result, the water deficient level gradient and/or temperature gradient will advantageously be more uniform (as compared to the electrolyzer cell stack 750) on the cell 761 level and the electrolyzer cell stack 760 level. Accordingly, the cavity or stomata design of each of the plurality of cells 761 may advantageously be independently modified across each of the cells 761 to accommodate different electrolyzer cell stack designs.

### Methods of Manufacturing

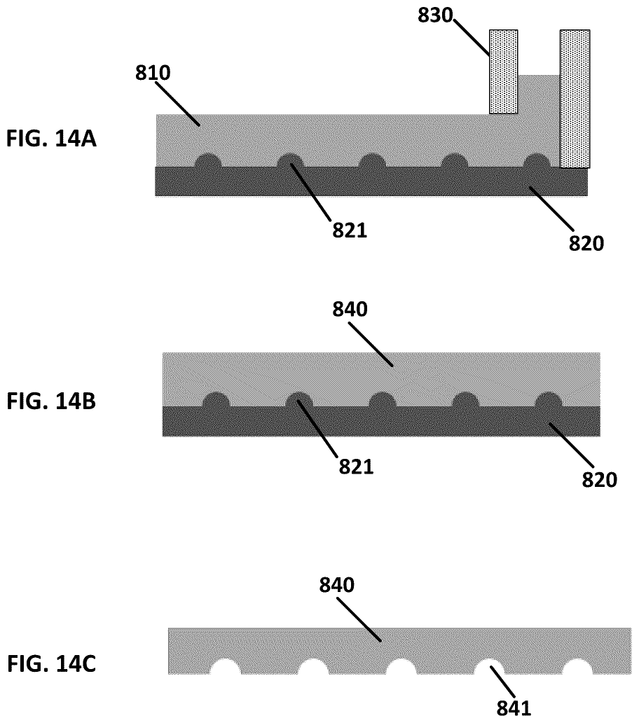

Described hereinafter are methods of manufacturing a porous layer including stomata according to embodiments of the present disclosure. Any one of the porous layers including stomata according to the embodiments of FIGS. 8A, 8B, 9A-E, 10A-10F, 11A-11E, and/or 12A-12D may be manufactured using the methods described below. Each of the methods illustrated by FIGS. 14A-14C, 15A and 15B, and 16A-16E, respectively, include casting or pouring a slurry including metal powder to form a green state tape. In some embodiments, a doctor blade (e.g., doctor blade 830) may be used to cast or pour the slurry onto a surface. The doctor blade may selectively change a thickness of the slurry cast on to the surface. After drying the cast or poured slurry may form the green state tape. As used herein, “green state” may refer to a composition or structure that has not undergone heat treatment (e.g., sintering) to form a solid and/or porous mass. The slurry may include an organic binder that may be dissolved in the slurry and bonds the metal powder together after the solvent has evaporated (e.g., in the green state).

The metal powder 810 may be a titanium (Ti) powder. In some examples, the metal powder may additionally or alternatively include an oxidation-resistant material such as, but not limited to, platinum (Pt), gold (Au), chromium (Cr), silicon (Si), zirconium (Zr), yttrium (Y), niobium (Nb), and/or aluminum (Al). This oxidation-resistant metal may be particularly advantageous in limiting corrosion in an oxygen environment on the anode side of the cell. Alternative metal powders may include titanium carbide (TiC), titanium nitride (TiN), titanium diboride (TiB₂), or combinations thereof. In some examples, the metal powder may include one or more organic additives.

In some examples, illustrated in FIGS. 14A-14C, the stomata may be formed by casting a slurry on to a patterned substrate. In a first act, shown in FIG. 14A, the slurry 810 is cast or poured on to a patterned substrate 820. The thickness of the slurry 810 cast on the patterned substrate 820 may correspond to a thickness of the porous layer. The patterned substrate 820 may include a plurality of protrusions 821 extending upward from the patterned substrate 820. Each of the protrusions 821 may correspond to a cavity or stoma formed in the porous layer. Accordingly, the number and location of protrusions 821 may correspond to the desired number of and location of stomata in the porous layer. The size and shape of the plurality of protrusions 821 may correspond to or be the same as the size and shape of the stomata in the porous layer. Accordingly, the patterned substrate 820 may include protrusions 821 having different sizes and/or shapes.

In a second act, illustrated in FIG. 14B, the slurry 810 may dry into a green state tape 840. After drying, the green state tape 840 may be removed or separated from the patterned substrate 820. FIG. 14C illustrates the green state tape 840 after it has been removed or separated from the patterned substrate 820. After the green state tape 840 has been removed from the patterned substrate 820, the green state tape 840 may include a plurality of dimple-like negative shapes 841 corresponding to the protrusions 821 of the patterned substrate 820.

In a third act, the green state tape 840 may be sintered to form the porous layer including stomata. During sintering of the green state tape 840, the plurality of dimple like negative shapes 841 may form the stomata in the porous layer.

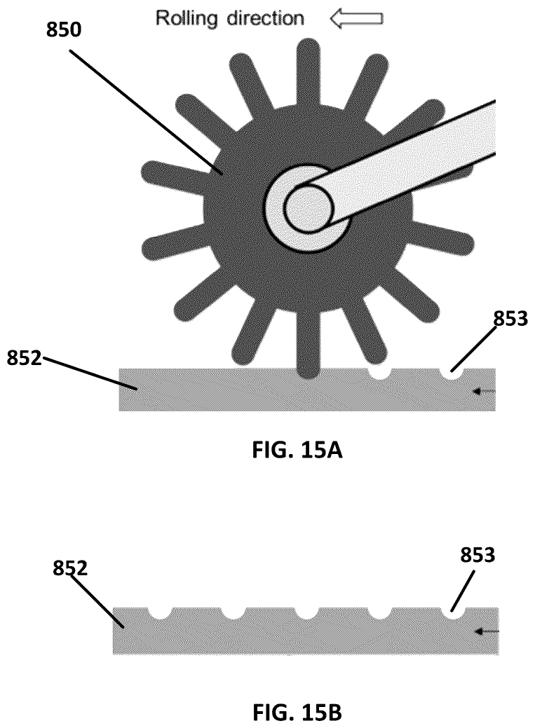

In other examples, illustrated in FIGS. 15A and 15B, the stomata may be formed using a patterned roller 850. As shown in FIG. 15A, the patterned roller 850 may be used to form negative shapes on a green state tape 852. The green state tape 852 may be formed by allowing the solvent in a slurry cast or poured on a surface (e.g., by a doctor blade) to evaporate. The patterned roller 850 may include a unique protruded pattern corresponding to a desired pattern of stomata in the porous layer. As the patterned roller is rolled across the green state tape 852, negative shapes 853 may be formed in the green state tape 850. FIG. 15B illustrates the green state tape 852 after the patterned roller 850 has formed the negative shapes in the green state tape 852. The green state tape may subsequently be sintered to form a solid porous layer. During sintering of the green state tape 852, the plurality of negative shapes 853 may form the stomata in the porous layer.

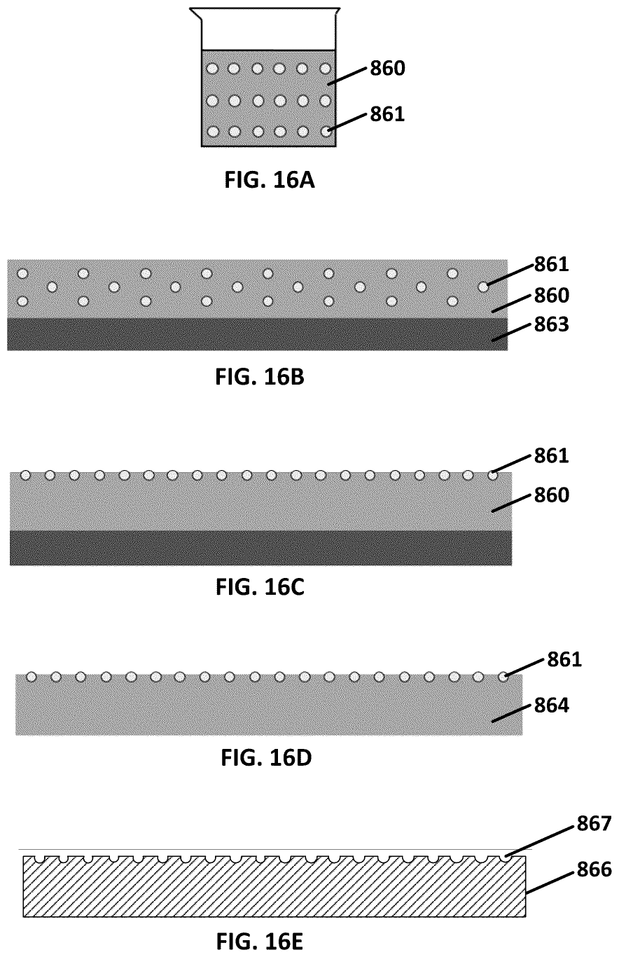

In other examples, illustrated in FIGS. 16A-16E, organic sacrificial material may be used to form the stomata. For example, as illustrated in FIG. 16A, a slurry 860 may further include organic sacrificial material 861. The organic sacrificial material 861 may not be soluble in the slurry 860. The organic sacrificial material 861 may be present in the slurry 860 in the form of a plurality of pellets or beads. The organic sacrificial material 861 may have a different density than the slurry 860.

As illustrated in FIG. 16B, the slurry 860 including the organic sacrificial material 861 may be cast on to a surface or substrate 863. As illustrated in FIG. 16B, after being cast, the organic sacrificial material 861 may be distributed throughout the slurry 860 disposed on the surface or substrate. As illustrated in FIG. 16C, due to its density, the organic sacrificial material 861 may segregate from the slurry 860. In some embodiments, as illustrated in FIG. 16C, the organic sacrificial material may float to a top surface of the slurry 860. In other examples, the organic sacrificial material 861 may settle to a bottom of the slurry 860.

As illustrated in FIG. 16D, after the organic sacrificial material 861 has segregated from the slurry 860 and after the solvent in the slurry has evaporated forming the green state tape 864, the green state tape 864 may be removed or separated from the substrate 863. Further, after the green state tape 864 has been separated from the substrate 863, the green state tape 864 may go through a sacrificial material removal process to remove the organic sacrificial material 861. During the sacrificial material removal process, the green state tape 864 including the organic sacrificial material 861 may be heated to melt or evaporate the organic sacrificial material 861. The organic sacrificial material 861 may melt and/or evaporate at a lower temperature than a melting temperature of the metal powder included in the slurry. In some examples, the organic sacrificial material 861 may be removed in stages. In these examples, the organic sacrificial material 861 may include two or more different materials each melting at a different temperature.

After the sacrificial material removal process, the voids created by the removal of the organic sacrificial material 861 become the negative spaces that will become the stomata after sintering of the green state tape 864. After the sacrificial material removal process, the green state tape 864 may be sintered to form the solid porous layer and stomata. FIG. 16E illustrates the porous layer 866 including stomata 867.

In some examples, the stomata in the porous transport layer may be formed using a chemical etching method. Similar to the organic sacrificial material in the method described above with respect to FIGS. 16A-16E, the slurry may further include metallic sacrificial material. The metallic sacrificial material may include large stainless steel pellets added to the slurry. The metallic sacrificial material may have a melting temperature higher than the melting temperature of the metal powder included in the slurry.

In some examples, a green state tape including the metallic sacrificial material may be sintered without melting the metallic sacrificial material. For example, the metal powder in the slurry may include titanium (Ti) and have a sintering temperature in the range of 800 °C to 1100 °C and the metallic sacrificial material may be stainless steel having a melting temperature in the range of 1400 °C to 1530 °C. Accordingly, the sintering temperature of the green state tape will not cause the stainless steel particles to be melted. After sintering, the porous transport layer will include discrete stainless steel particles inside or on the surface of the porous layer. After sintering, chemical etching may be performed to remove the metallic sacrificial material from the porous layer without affecting the porous layer. For example, hydrochloric acid, nitric acid, or sulfuric acid may be used to etch stainless steel components without affecting a titanium structure of the porous layer.

In some examples, laser abrasion may be used to form stomata in the porous layer. In some examples, a green state tape may be sintered to form the porous layer. One or more laser beams may then be used to form the stomata on the porous layer. A laser beam may impinge on a surface of the porous layer at a location or locations on the porous layer at which a cavity or stoma is to be formed. A focal time and/or energy of the laser beam may depend on the material including the porous layer. A focal time and/or energy of the laser beam may depend on the depth and/or shape of the stomata.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A porous transport layer of an electrochemical cell, the porous transport layer comprising:
stomata positioned on a surface of the porous transport layer,
wherein the porous transport layer is configured to be positioned between a membrane and an anode flow field of the electrochemical cell such that the stomata are positioned on the surface of the porous transport layer adjacent to the anode flow field,
wherein the porous transport layer is configured to convey a two-phase mixture of liquid and gas,
wherein each stoma of the stomata has a width or diameter in a range of 0.1-50 microns,
wherein each stoma of the stomata extends 1-50% into the surface of the porous transport layer from the anode flow field toward the membrane, and
wherein the stomata are configured to facilitate a transfer of gas from the porous transport layer into the anode flow field of the electrochemical cell.

2. (canceled)

3. The porous transport layer of claim 1, wherein the porous transport layer comprises a titanium porous sintered layer, titanium mesh, titanium fiber felt layer, or a combination thereof.

4.-5. (canceled)

6. The porous transport layer of claim 1, wherein at least one stoma of the stomata has a semispherical shape, conical shape, frustoconical shape, a rectangular shape, a tetrahedron shape, pyramid shape, or a prolate spheroid shape.

7. The porous transport layer of claim 1, wherein the stomata comprise a first stoma having a first shape and a second stoma having a second shape that is different from the first shape.

8. The porous transport layer of claim 1, wherein the stomata comprise a first stoma having a first size and a second stoma having a second size that is different from the first size.

9. The porous transport layer of claim 1, wherein two or more stoma of the stomata are connected by a groove in the surface of the porous transport layer.

10. The porous transport layer of claim 1, wherein the two-phase mixture includes a first flow comprising a liquid flowing away from the anode flow field toward the membrane of the electrochemical cell and a second flow comprising a gas flowing from the membrane toward the anode flow field of the electrochemical cell.

11.-12. (canceled)

13. An electrochemical cell comprising:
an anode flow field; and
a porous transport layer adjacent to the anode flow field, the porous transport layer configured to convey a two-phase mixture of liquid and gas,
wherein stomata are positioned on a surface of the porous transport layer adjacent to the anode flow field,
wherein each stoma of the stomata has a width or diameter in a range of 0.1-50 microns,
wherein each stoma of the stomata extends 1-50% into the surface of the porous transport layer from the anode flow field toward a proton exchange membrane of the electrochemical cell, and
wherein the stomata are configured to facilitate a transfer of gas from the porous transport layer to the anode flow field.

14. (canceled)

15. The electrochemical cell of claim 13, wherein the porous transport layer comprises a titanium porous sintered layer, titanium mesh, titanium fiber felt layer, or a combination thereof.

16.-17. (canceled)

18. The electrochemical cell of claim 13, wherein at least one stoma of the stomata has a semispherical shape, conical shape, frustoconical shape, a rectangular shape, a tetrahedron shape, pyramid shape, or a prolate spheroid shape.

19. The electrochemical cell of claim 13, wherein the stomata comprise a first stoma having a first shape and a second stoma having a second shape that is different from the first shape.

20. The electrochemical cell of claim 13, wherein the stomata comprise a first stoma having a first size and a second stoma having a second size that is different from the first size.

21. The electrochemical cell of claim 13, wherein two or more stoma of the stomata are connected by a groove in the surface of the porous transport layer.

22. The electrochemical cell of claim 13, wherein the anode flow field comprises a plurality of lands configured to contact the porous transport layer and a plurality of channels configured to convey a fluid to and from the porous transport layer.

23. The electrochemical cell of claim 13, further comprising:
the proton exchange membrane disposed adjacent to the porous transport layer such that the porous transport layer is positioned between the anode flow field and the proton exchange membrane,
wherein the two-phase mixture includes a first flow comprising a liquid flowing away from the anode flow field toward the proton exchange membrane and a second flow comprising a gas flowing from the proton exchange membrane toward the anode flow field of the electrochemical cell.

24. The electrochemical cell of claim 13, wherein the electrochemical cell is configured to operate with 200 mV or less of pure resistive loss when operating at a current density of at least 3 Amp/cm².

25. The electrochemical cell of claim 13, wherein the electrochemical cell is configured to transfer 0.25-5 mL of water through the electrochemical cell per Amp per min.

26. An electrochemical cell stack comprising:
a first electrochemical cell having:
a first anode flow field; and
a first porous transport layer adjacent to the first anode flow field, the first porous transport layer configured to convey a two-phase mixture of liquid and gas,
wherein a first plurality of stoma is positioned on a surface of the first porous transport layer adjacent to the first anode flow field,
wherein each stoma of the first plurality of stoma has a width or diameter in a range of 0.1-50 microns,
wherein each stoma of the first plurality of stoma extends 1-50% into the surface of the first porous transport layer from the first anode flow field toward a first membrane of the first electrochemical cell, and
wherein the first plurality of stoma has a first pattern configured to facilitate a transfer of gas from the first porous transport layer to the first anode flow field; and
a second electrochemical cell having:
a second anode flow field; and
a second porous transport layer adjacent to the second anode flow field, the second porous transport layer configured to convey an additional two-phase mixture of liquid and gas,
wherein a second plurality of stoma is positioned on a surface of the second porous transport layer adjacent to the second anode flow field,
wherein each stoma of the second plurality of stoma has a width or diameter in a range of 0.1-50 microns,
wherein each stoma of the second plurality of stoma extends 1-50% into the surface of the second porous transport layer from the second anode flow field toward a second membrane of the second electrochemical cell, and
wherein the second plurality of stoma has a second pattern different from the first pattern of the first plurality of stoma configured to facilitate a transfer of gas from the second porous transport layer to the second anode flow field.

27. (canceled)

28. The electrochemical cell stack of claim 26, wherein the first pattern of the first plurality of stoma and the second pattern of the second plurality of stoma are configured to reduce a water deficient gradient and/or a temperature gradient in the electrochemical cell stack.

29.-36. (canceled)

37. The electrochemical cell stack of claim 26, wherein the two-phase mixture comprises a first flow comprising a liquid flowing away from the first anode flow field toward the first membrane of the first electrochemical cell and a second flow comprising a gas flowing from the first membrane toward the first anode flow field of the first electrochemical cell, and
wherein the additional two-phase mixture comprises a first flow comprising a liquid flowing away from the second anode flow field toward the second membrane of the second electrochemical cell and a second flow comprising a gas flowing from the second membrane toward the second anode flow field of the second electrochemical cell.

38.-46. (canceled)
